(19) United States
(12) Patent Application Publication
(10) Pub. No.: US 2007/0057391 A1
(43) Pub. Date: Mar. 15, 2007

(54) Method for forming ceramic ingot

(75) Inventors: Robert L. Ibsen, Santa Maria, CA (US); Thomas C. Chadwick, Nipomo, CA (US); Jacques Riddel, Santa Maria, CA (US); Luigi Campanale, Nipomo, CA (US); Jerry Donahue, Santa Maria, CA (US); Randy Oberg, Arroyo Grande, CA (US); Kenneth Groppetti, Santa Maria, CA (US)

Correspondence Address: CROWELL & MORING LLP;INTELLECTUAL PROPERTY GROUP, P.O. BOX 14300, WASHINGTON, DC, 20044-4300, US

(73) Assignee: Den-Mat Corporation, Santa Maria, CA (US)

(21) Appl. No.: 11/498,018

(22) Filed: Aug. 3, 2006

Related U.S. Application Data
(60) Provisional application No. 60/705,449, filed on Aug. 5, 2005.

(51) Int. Cl. A61C 13/00

(52) U.S. Cl. 264/16; 264/225; 425/175

(57) ABSTRACT

A method for forming a ceramic ingot. A mold is filled with ceramic powder. The mold is subjected to a heating process to fuse together grains of the ceramic powder. The fused ceramic is then removed from the mold to form a ceramic ingot.

### BACKGROUND

1. Field of the Invention

The invention relates to the dental arts and the ceramic arts.

2. State of the Art

Dental restorations are well known in the art. Common dental restorations include inlays, onlays, crowns, and veneers. One method of forming dental restorations involves using the lost wax technique. The lost wax technique is a well-known method in the metallurgical sciences wherein a wax or polystyrene model is replaced by molten metal. In the case of dentistry, the wax model is replaced by ceramic after the wax is burned out.

The formation of a dental restoration by the lost wax technique previously required the following steps:

1. Tooth preparation: In this step a portion of the tooth was removed, for example the removal of 1.5 to 2 mm of tooth structure, i.e., enamel or dentin. This step was necessary to provide a preparation of the tooth without undercuts and to allow for a final metal ceramic or metal resin restoration that was of adequate thickness.

2. Impression (negative mold): An impression material such as a hydrocolloid, polyester rubber, or vinyl polysilicone (VPS) was used to make an impression of the prepared teeth.

3. Stone model formation: The impression was then used by the laboratory technician to create a stone or epoxy model with removable dies that were an accurate copy of the prepared tooth, i.e., to create a positive replication of the tooth (see FIG. 1).

4. Spacer application: A die spacer was then applied to the die, which affords appropriate relief in a range of 20 to 36 microns to allow space for a dental cement or bonding agent to secure the final restoration to the patient's prepared tooth (see FIG. 2).

5. A lubricant or a release agent was then placed over the die spacer.

6. Wax up: A wax model of the dental restoration was then fabricated over the lubricated die. That is, the wax was built up over the stone model of the tooth to the desired dimension of the final restoration (see FIG. 3).

7. Investing/Casting: The wax pattern was then removed from the stone model and invested in high heat investment or refractory material and cast from a molten metal using the “lost wax” technique and a centrifuge process to form a metal coping or substructure of the restoration.

8. The ceramic or visible portion of the restoration was then formed by applying and baking successive layers of ceramic powders mixed with distilled water or other types of ceramic building-up liquids, first to opaque over the metal coping to hide the metal color and then to shape the ceramic from its various transition shades to create as natural an appearance as possible. The temperatures of this baking were a function of individual vendor's particular protocol.

An improvement on this technology was the development of pressable all-ceramic restorations. These restorations, which eliminated the use of metal, are so named because the ceramic is pressed into a void in the refractory material. In the first step of this process, a wax model of the final restoration or veneer is formed by the method described above in steps 1-6. The model is then mounted on a pedestal connected to a ring former base. The model is mounted on the pedestal using a wax sprue (see FIG. 4). Several restorations can be mounted on a single pedestal using one sprue per restoration. The sprues are generally mounted at an angle of between 30° and 60° with respect to the upper surface of the pedestal. The pedestal and sprue elevate the model up from the ring former base, suspending the model in the air. In order to determine the amount of ceramic required to form the restoration, the model(s) and sprue(s) are weighed. This is typically accomplished by weighing the ring former/pedestal without the sprues and models, weighing ring former/pedestal and sprues and models together, and then subtracting the former from the latter.

A ring is then placed around the pedestal on the ring former base. The ring fits snugly on a raised portion of the ring former base (see FIG. 5). The ring completely encompasses the pedestal, sprues, and models. Typically, at least 10 mm clearance is provided for all around the model(s) by the ring, which is typically made of paper but can also be made of an elastomer. The size of the ring is typically chosen based on the determined weight of the wax. A stabilizer ring may be placed over the upper rim of the ring in order to provide additional support (see FIG. 6). The ring is then filled with a castable refractory material, also known as investment. Typically, the ring volume is slowly filled to ensure there is minimal formation of air bubbles in the investment material. Typically, all areas of the mold form that are to come into contact with the refractory material are lubricated to prevent adhesion to the refractory. Typically, petroleum jelly or a Teflon-Silicone spray are used as lubricants.

The refractory material is then allowed to solidify resulting in a refractory material cylinder. Typically, solidification requires at least a half hour of set time. The refractory material cylinder is then removed from the ring former base/pedestal and the leveling ring. This is typically accomplished by twisting the base/pedestal and the leveling ring so as to break away the refractory material from the surfaces of each. The paper ring is then removed. Any roughness on the mold is then removed by a cutting instrument. The paper ring may also leave a seam down the side of the refractory material cylinder. This seam can be smoothed in a similar manner.

The refractory material cylinder encompassing the wax sprue(s) and model(s) is then placed in a burnout furnace or oven. The cylinder is placed with the pedestal opening down. The burnout oven is typically set at around 900° C. In this heated environment, the wax composing the sprue(s) and model(s) melts and then burns or evaporates off through the void created by the pedestal. A cylinder of the refractory material remains with a negative of the shape of the model connected to a passageway, created by the void left by the pedestal, via the void left by the sprue. The pedestal can also be made of wax and detachable from the ring former base. In this case, the pedestal is not lubricated and does not break off with the base but remains inside the refractory material cylinder. The wax pedestal is then burned off as described above leaving the void described above.

Ceramic is then pressed into the model negative (restoration mold) through the void left by the pedestal. This is typically accomplished by first selecting the amount and size of ceramic ingots needed to form the restoration. This is calculated based on the measured wax weight. Typically, ceramic ingot manufacturers provide charts correlating the size and number of ingots to use with the measured weight of the wax. The ceramic ingot is then placed into the hole in the refractory cylinder. A plunger is then placed into the hole above the ceramic (see FIG. 7). The plunger is typically made of aluminum oxide although other refractory materials may be used. The plunger is then used to force the ceramic into the restoration mold. The pressing process typically stops when ceramic fills the voids left by the model and the sprue. This whole process typically takes place in a press furnace. The pressing of the ceramic typically takes place under a high vacuum and at high temperatures up to 1200° C. (2192° F.). Press furnaces can be preprogrammed with certain heating and vacuum press cycles for different types and amounts of ceramic. The ceramic ingot and plunger may also be preheated before being placed into the refractory cylinder.

After the mold is removed from the press furnace and cooled, the next step involves the divesting of the refractory material cylinder from the ceramic restoration. This is typically accomplished by cutting the refractory cylinder with a separating disk at the point where the bottom of the plunger lies. This point is estimated by placing an identical plunger next to the embedded plunger and marking on the refractory cylinder surface the end of the plunger (see FIG. 8). The cylinder is cut all along its circumference and then the material is pried off using a plaster knife or similar tool. The remaining investment material is then removed with a sandblaster using a suitable abrasive such as alumina, quartz, or glass beads.

The sprue is then removed from the restoration by cutting the sprue near its base using a diamond disk (see FIG. 9). The remaining material is then removed using a ceramic stone or other abrasive. The ceramic restoration can then be fit on the stone model after removing the spacer and acute adjustments can be made as required.

As described above, the formation of pressable ceramic dental restorations typically uses ceramic ingots as the source of ceramic. These ingots are typically formed by compacting ceramic powders into shapes of simple geometry, such as cylinders, by uniaxial die pressing. To form a cylindrical ceramic ingot by uniaxial die pressing, the ceramic powder is first mixed or coated with an organic binder material. This binder material is needed to enable the ceramic powder to maintain a shape. The binder-coated ceramic is then loaded into the cylindrical cavity of a thick walled metal die and a tight fitting cylindrical plunger is inserted in the cylindrical hole above the ceramic powder and pressure is applied to the plunger. This creates a cylindrical ceramic compact. After the pressure on the plunger is removed the resulting ceramic compact or ingot is ejected from the die. The cylindrical ingot is then transferred to a furnace where the ceramic is carefully heated at low temperature to decompose the binder. This binder removal step is necessary because the binder is not wanted in the final ceramic restoration. After the binder has been removed, heating is continued in order to fuse together ceramic grains to produce a cylindrical ceramic piece. Heating can be carried out under conditions that eliminate all voids from the piece so that a fully dense ceramic is produced or heating can be terminated before full density is achieved and a less dense, porous object can be produced.

However, the uniaxial die pressing process is expensive and time consuming and is not suited for extremely high volume production of ceramic ingots. Therefore, there remains a need for a method for forming ceramic ingots that is less time consuming and less expensive compared to uniaxial die pressing, and can be utilized to produce ingots at high volume but still provides the same quality ceramic restorations after being pressed into a mold. There further remains a need for a process that does not require the use of a binder.

### SUMMARY OF THE INVENTION

One embodiment of the present invention is a method for forming a ceramic ingot. In a first step, a mold is filled with a ceramic powder. The mold and the ceramic powder are then heated until the ceramic powders begin to fuse together. The mold is then removed from the heat and allowed to cool. The fused ceramic ingot is then removed from the mold. A partially fused open cellular ingot is formed.

Another embodiment of the present invention is a method for forming a mold for forming a ceramic ingot. A refractory metal structure having an inner size and shape of a ceramic ingot is constructed. An oxide layer is formed on the surface of the refractory metal. The oxide layer is adherent to the refractory metal at temperatures of at least 1500° F.

Another embodiment of the present invention is a method for forming a mold for forming a ceramic ingot. A ceramic is shaped into a structure having an inner size and shape of the ceramic ingot desired to be formed. The shaped ceramic is fired to maturity.

Another embodiment of the present invention is a mold for forming a ceramic ingot. The mold is a refractory metal cylinder having an inner diameter equal to the desired diameter of the ceramic ingot. The surface of the refractory metal has an oxide layer formed thereupon. The oxide layer is adherent to the refractory metal at temperatures of at least 1500° F.

Another embodiment of the present invention is a mold for forming a ceramic ingot. The mold is a ceramic structure having an inner dimension equal to the inner dimension of the desired ceramic ingot. The ceramic structure is refractory enough to withstand repeated firings at temperatures of at least 1500° F.

Another embodiment of the present invention is a mold-filling device. The mold-filling device can be used for filling a mold for forming a ceramic ingot. The device includes means for engaging a mold for forming a ceramic ingot. The device also includes vacuum means for introducing ceramic powder into the mold. The device also includes means for disengaging the filled mold.

Another embodiment of the present invention is a method for making a ceramic dental restoration. A mold is filled with a ceramic powder. The mold and the ceramic powder are then heated until grains of the ceramic powder fuse together. The mold is then removed from the heat and allowed to cool. The fused ceramic ingot is then removed from the mold. A wax model of a dental restoration is created. The wax model is then mounted on a ring former base using a wax sprue. A refractory material shape is formed around the wax model. The wax from within the refractory material shape is removed to form a refractory material shape with a void in the shape of the wax model. The fused ceramic ingot is pressed into the void to fill the void with ceramic. The refractory material is removed from about the pressed ceramic to provide a solid ceramic dental restoration.

Another embodiment of the present invention is a method for forming a ceramic ingot. An unconsolidated ceramic is compacted into a desired shape. The unconsolidated ceramic is heated to fuse together grains of the ceramic. The fused ceramic is cooled to form a fused ceramic ingot. The fused ceramic ingot is formed without the use of a binder material.

### BRIEF DESCRIPTION OF THE DRAWINGS

FIG. 1 shows a stone model of a patient's teeth.

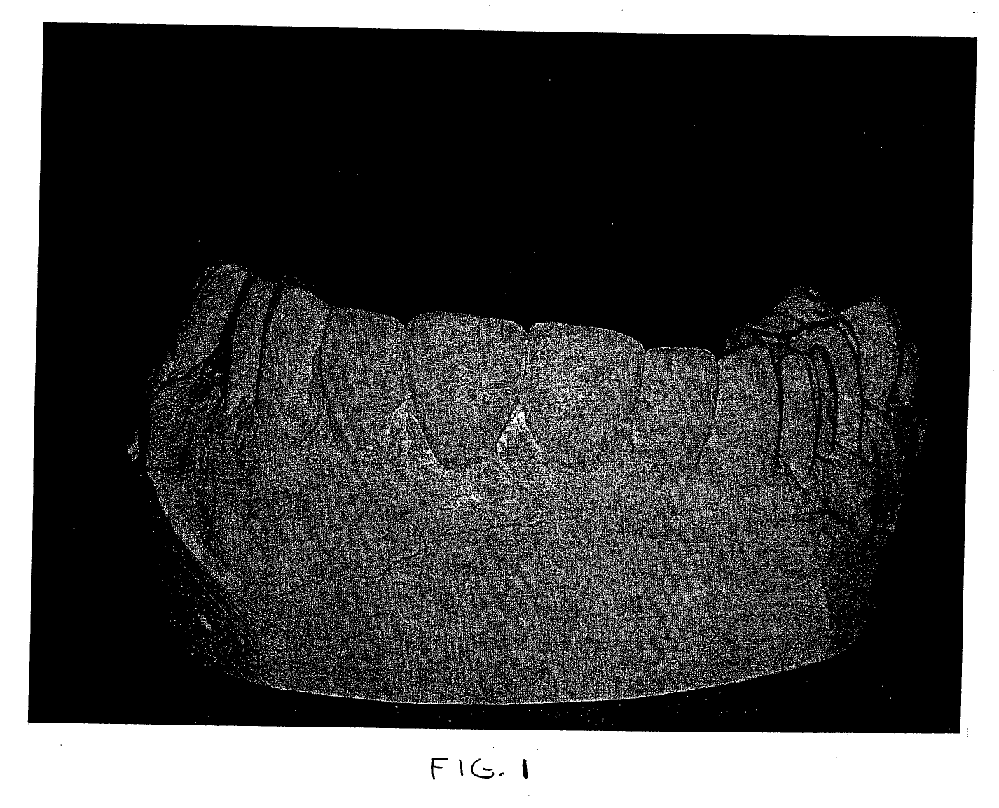

FIG. 2 shows a die spacer applied to the tooth model.

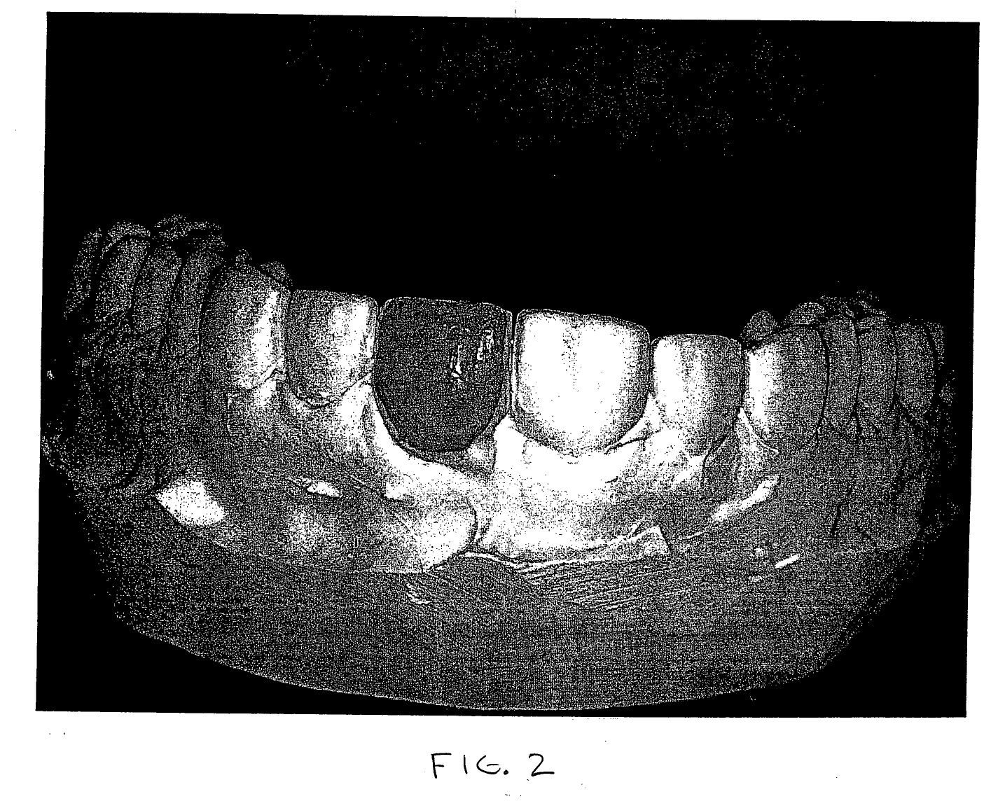

FIG. 3 shows the creation of the wax model of the dental restoration.

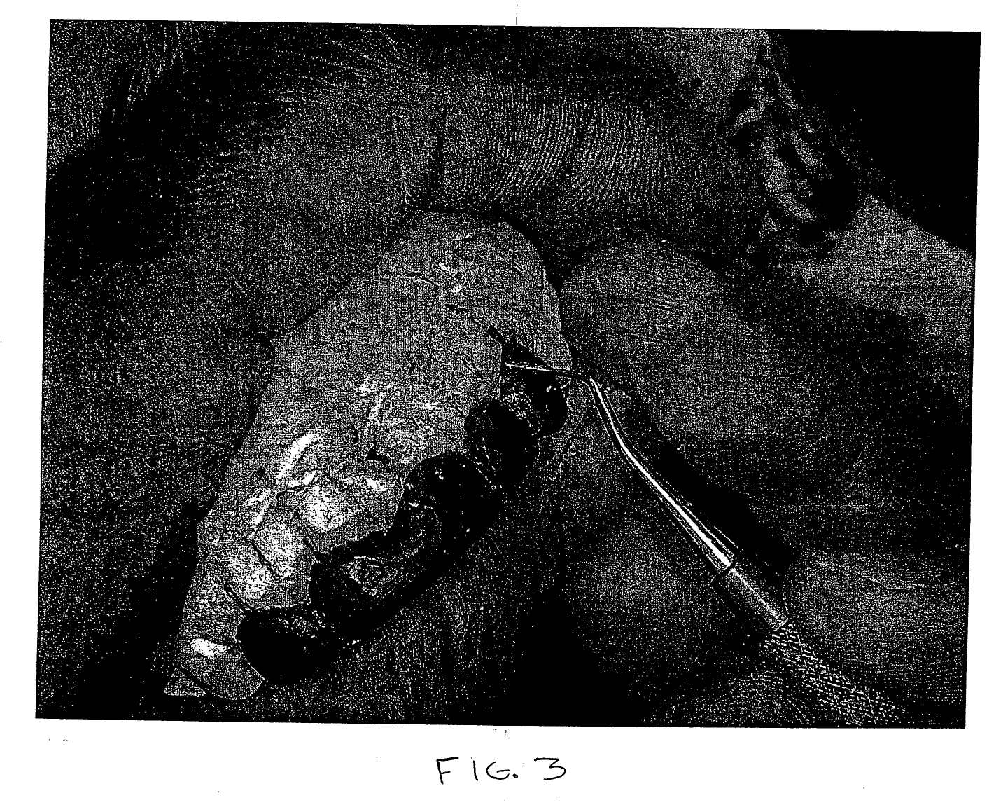

FIG. 4 shows the mounting of the wax models to a pedestal/ring former base using wax sprues.

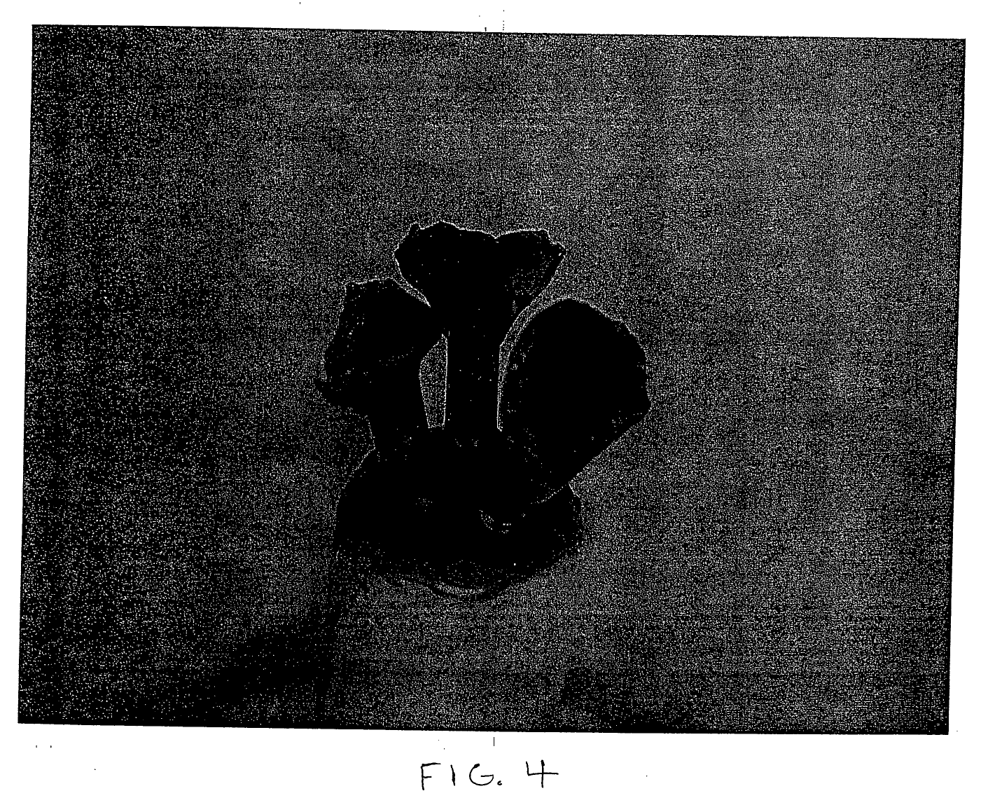

FIG. 5 shows the tight fit between the ring former base and a ring.

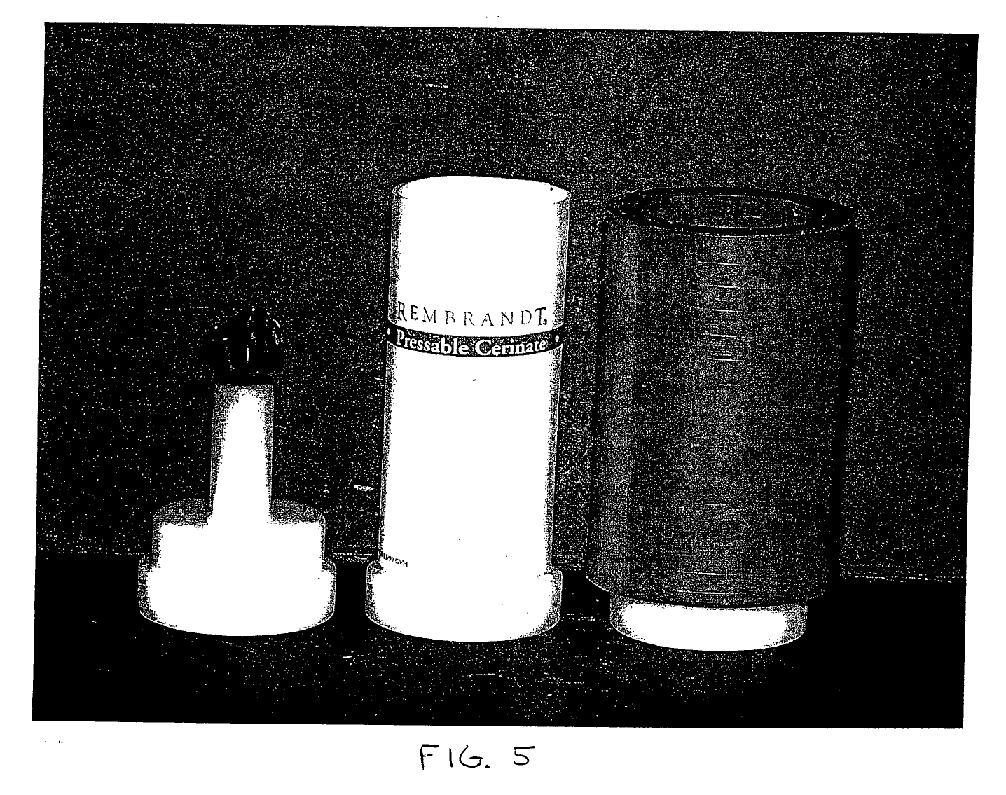

FIG. 6 shows the application of a stabilizer ring to the upper rim of the ring.

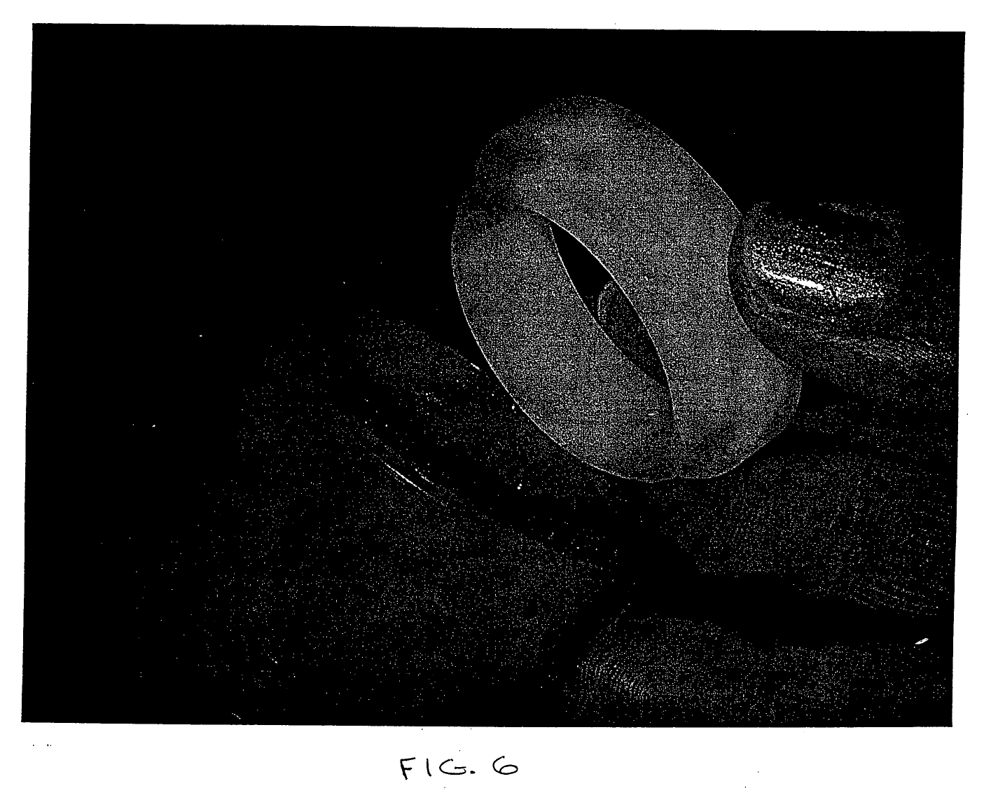

FIG. 7 shows the positioning of a plunger into the void left by the pedestal.

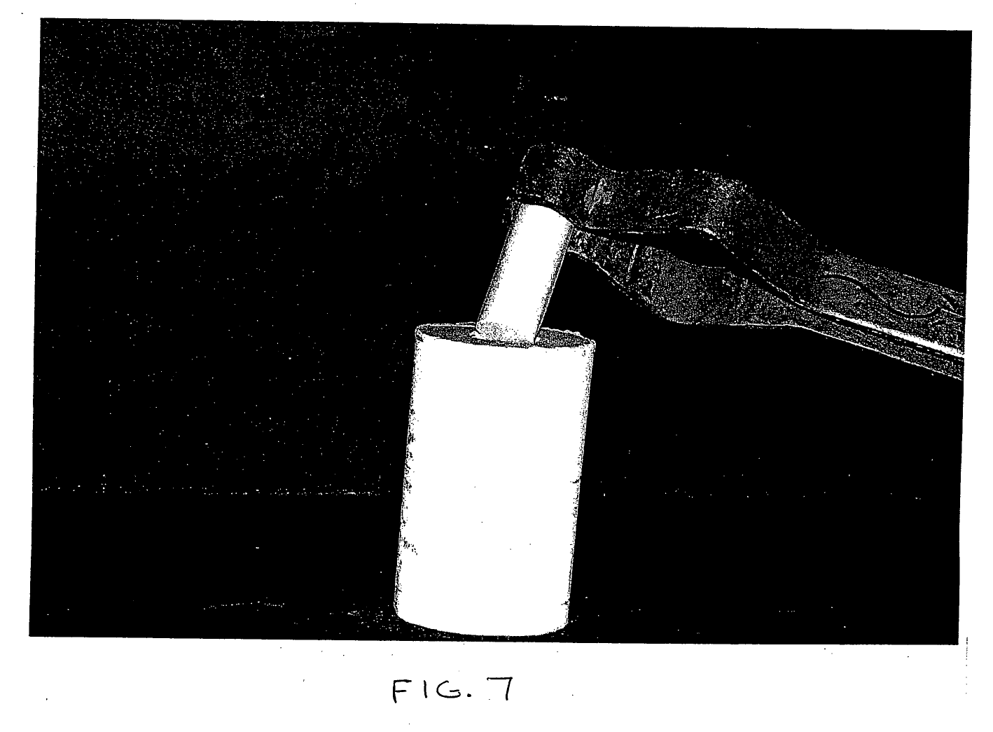

FIG. 8 shows the estimation of the level of the bottom of the plunger after ceramic is pressed into a mold.

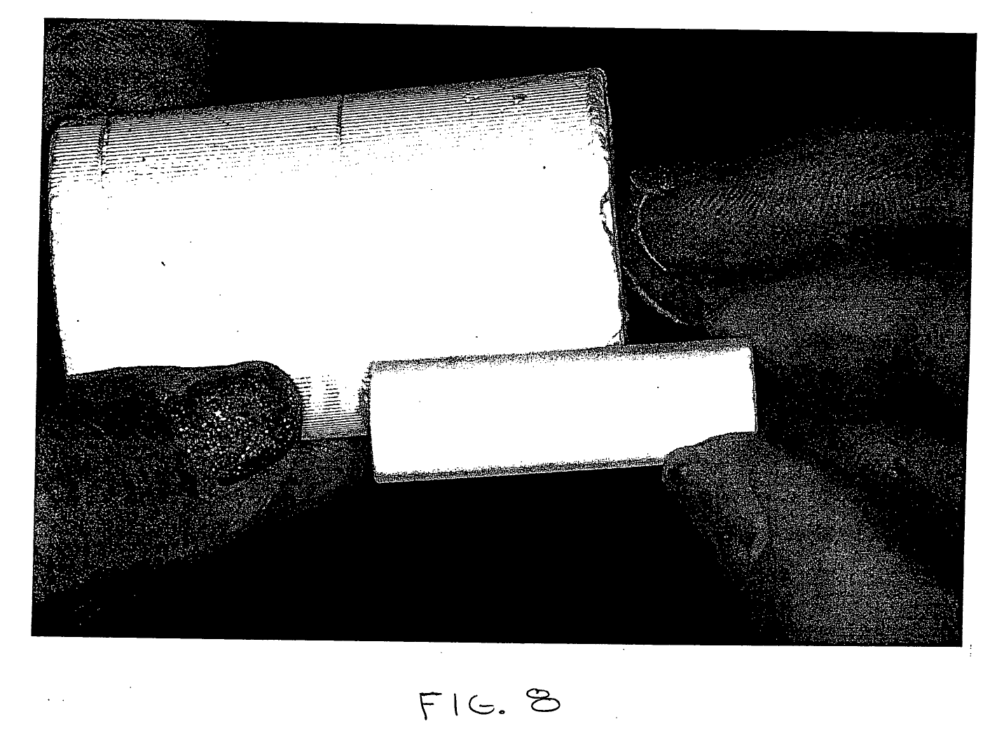

FIG. 9 shows the removal of a ceramic sprue from the final dental restoration.

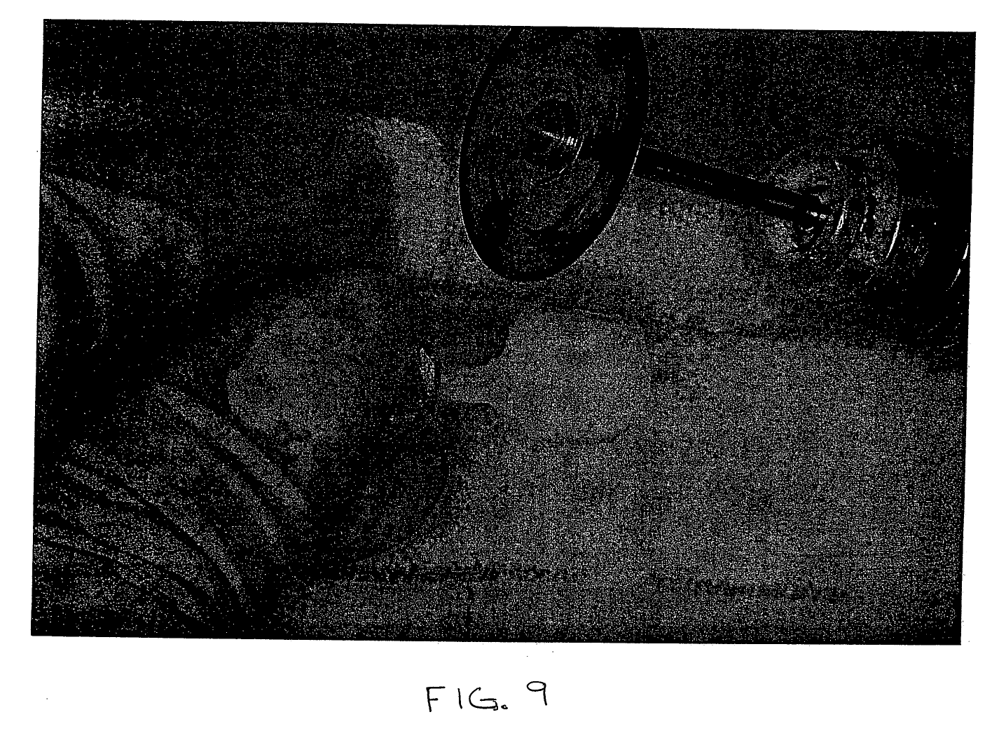

FIG. 10 shows a mold-filling device of one embodiment of the present invention.

FIG. 11 shows a disassembled view of the mold-filling device.

FIG. 12 shows the loaded mold ring in the mold-filling device

### DETAILED DESCRIPTION

The drawings and the following detailed descriptions show specific embodiments of the invention. Numerous specific details including materials, dimensions, and products are provided to illustrate the invention and to provide a more thorough understanding of the invention. However, it will be obvious to one skilled in the art that the present invention may be practiced without these specific details.

One embodiment of the present invention is for a method for making a ceramic ingot. The ceramic ingot can be used to fabricate a ceramic dental restoration. The ceramic ingot may be an open-cell porous structure or a substantially solid structure. The open-cell porous structure has a series of holes or tunnels interconnected throughout the ceramic ingot. Porosity is defined as the ratio of the volume of the holes or tunnels throughout a structure to the volume of the entire structure. In a preferred embodiment, the porosity of the ceramic ingot is between 10 and 50 percent.

The ceramic ingot is formed from a starting material of unconsolidated ceramic such as ceramic powder or particles of ceramic. Such raw material ceramic is readily available from a variety of suppliers. The ceramic powder is provided to a mold to fill the mold. The mold is then placed in a furnace and heated or sintered until the grains of the ceramic powder begin to fuse together. The mold is then removed from the furnace and allowed to cool. The fused ceramic ingot is then removed from mold.

The sintering results in the fusing of ceramic grains at the edges but not throughout the ceramic. This partial fusing of grains is referred to as partially mature ceramic throughout the present application. This results in a ceramic ingot with a series of interconnected holes or tunnels throughout its volume. This interconnected pathway is referred throughout the present application as open-celled. Preferably, the porosity of the ceramic ingot is between 10 and 50 percent. Contrastingly, prior art ceramic ingots, which are fully mature, exhibit a porosity of less than 1 percent. In the case where the ceramic has an ultimate density of 2.40 g/cm³, the partially mature ceramic ingot will typically have a density of between 1.72 g/Cm³ and 1.92 g/Cm³.

Alternatively, the mold may be heated in the furnace until the ceramic powder is fully fused together and then removed, allowed to cool and ejected as above. The resultant ingot in this embodiment has a density of around 2.4 g/cm³ and has substantially no open pores. This type of ingot is referred to hereinafter as a fully mature ceramic ingot.

The mold used for the formation of the ingot can be any mold that can withstand the firing temperatures associated with the formation of the ingot. Exemplary materials for the mold include ceramics, such as pyrophyllite and steatite, and refractory metals. In a preferred embodiment the mold is a refractory metal alloy mold such as a nickel-chromium-iron alloy such as Inconel 600 or Inconel 601, Type 304 stainless steel, Type 316 stainless steel and Type 321 stainless steel. The mold may also be composed of any alloys containing by weight percentage, nickel (9%-80%), chromium (14%-25%), iron (0%-75%), manganese (0%-2%), aluminum (0%-6%), molybdenum (0%-3%), titanium (0%-1%), copper (0%-1%), silicon (0%-1%), carbon (0%-1%), phosphorous (0%-0.5%) and sulfur (0%-0.5%) or any alloy whose surfaces oxidize to an oxide coating that is adherent under conditions where the ceramic is being molded and fired to maturity.

In an alternative embodiment, an adherent oxide layer may be formed on the metal to form a suitable mold. In this embodiment, metals that are not sufficiently resistant to oxidation, or metals that would be satisfactory at lower temperatures but are instead being used at higher temperatures where oxidation is more rapid can be used as the mold material as well as the materials listed above. In this embodiment, the surface of the metal is treated to form an adherent oxide layer. Preferably, the oxide layer is formed by dip-coating the metal in TiO₂, SiO₂ or Al₂O₃—P₂O₅ sols. The sols can be prepared by any method known in the art. Preferably the sols are prepared by the method of Shin et al. disclosed in “Sol-Gel Derived TiO₂ Coating for Chemical Protection of Stainless Steel”, Mat. Sci. Forum, Vols. 486-487, pp. 5-8 (2005), which is hereby incorporated by reference in its entirety. Other sol formation methods are described in U.S. Pat. No. 6,036,762 issued to Sambasivan; U.S. Pat. No. 6,461,415 issued to Sambasivan et al.; published U.S. Patent Application Nos. 2003/0138673, 2004/0011245, 2004/0138058, 2004/0151924, 2004/0206267, and 2005/0106384.

In order to form the adherent oxide layer, the metal surface may first be oxidized by heating in air. The oxidized metal may then be dip-coated in the appropriate sol suspension and then refired to produce a thin, adherent, inert coating. For example, the metal may first be oxidized by heating in air. The heating process may include a temperature of 1500° F. with a 12 minute hold time. The oxidized metal can then dipped into the sol and allowed to air-dry. The air-dried dipped metal can then be heated again. Once again, a temperature of 1500° F. with a 12 minute hold time may be used. Alternatively, the adherent oxide layer could be formed by oxidizing in molten oxidizing salt baths or oxidizing with chemical oxidants in aqueous solutions.

In another embodiment of the invention the mold can be constructed of a ceramic material that is capable of being manufactured into a mold of the proper dimensions to produce the desired ceramic ingot, referred to herein as a machinable ceramic. The ceramic that is used to make the mold must be refractory enough to withstand repeated firings at temperatures sufficiently high to produce the desired, partially sintered ingots. Preferably the ceramic is pyrophyllite, a naturally occurring mineral. Pyrophyllite is readily available and is marketed commercially under the name “Machinable Aluminum Silicate” as well as the trade names Lava™, Ceramit and Wonderstone. As supplied by the manufacturer the material is rather soft and while it is still in that state it can be turned, milled, drilled, filed or sawn with either hand or machine tools.

In one embodiment of the invention the ceramic mold can be formed from ceramic precursor materials. In this embodiment, the commercially available ceramic such as pyrophyllite is first machined into the desired shape for a mold for forming an ingot of a desired size and shape. The mold shaped ceramic is then fired to maturity after the machining operation is complete. For example, pyrophyllite can be fired to maturity at a temperature range of 800° C.-1300° C. (1472° F.-2372° F.). The resulting ceramic mold is durable, has a relatively low thermal expansion, and is hard and resistant to wear. The mold shaped ceramic could be fired to maturity on the lower end of the firing temperature range (800° C.-1100° C.). After this low temperature firing, the ceramic is not quite as hard as when fired at higher temperatures, the finished dimensions of the fired piece are slightly larger than the original, unfired dimensions and the fired ceramic piece has a service limit of 1000° C. (1872° F.). The ceramic could also be fired to maturity at temperatures>1100° C. (>2012° F.). After this high temperature firing, the service limit increases to 1100° C. (2012° F.) and the firing expansion is decreased.

Other machinable ceramics such as steatite, also known as massive talc or soapstone and Macor® can be used in the same way as pyrophyllite although consideration of the service temperature of the mold and the service limit of the ceramic should be made when choosing the ceramic to be used.

In another embodiment of the invention, the ceramic mold can be formed from machinable blanks. In this embodiment, machinable ceramic blanks are first prepared from ceramic powders. The blanks are made from ceramic powders by coating the powders with a binder, usually a combustible organic binder, and then pressing the coated powder in a mold at high pressure to produce a solid ceramic blank. At this stage the blank is soft and can be turned, milled, drilled, filed or sawn with either hand or machine tools. After shaping, the piece can be fired to burn out the binder and bring the ceramic to full density. Many different types of ceramics, including fired pyrophyllite and steatite, can be fabricated in this fashion and the times and temperatures required to make them fully dense vary over wide ranges. Ceramics made by this method typically exhibit firing shrinkage, which should be taken into account when the unfired piece is machined.

Another method of forming ceramic molds is to press them from ceramic powders that incorporate a binder. In this method, the powder is pressed directly into the shape of the desired mold. In practice, the ceramic powders are uniformly coated with a binder material and the coated ceramic powders are loaded into a die and pressed with a plunger to form a powder compact of the desired shape. After the compacts are removed from the die they are fired in a fashion similar to that described in the previous section. Thus, this method advantageously eliminates the machining of the ceramic. Accordingly, any ceramic that can withstand the temperatures required for sintering the ceramic ingot can be used in this embodiment for making the ceramic mold including but not limited to machinable ceramics.

The mold of the present invention may be a cavity with one end closed or both ends can be open. The mold may be either a single cavity mold or a multiple cavity mold where the mold is created by making multiple, closely spaced holes in a single block of metal or ceramic mold material. In order to produce cylindrical ceramic pieces a mold with a circular cross section is used but other simple mold cross sectional shapes (square, hexagonal, etc.) could be used to create ceramic pieces of different shape. The mold may be sized according to the desired size of the ceramic ingot to be formed.

In one embodiment of the invention, the mold can be fabricated as a cylinder, open at both ends. This type of mold will be referred to as a ring or mold ring. In this embodiment, the rings require a base plate, preferably made of the same alloy as the rings, or made of some other refractory metal or ceramic material. The base plate may just be a flat metal plate that can withstand the firing temperatures required to form the ceramic ingots. After each mold ring has been loaded with ceramic powder it can be placed on the base plate and the base plate can then be placed in a furnace after it has been completely loaded with ceramic powder-filled mold rings.

Many of the alloys that can be used for the mold rings can be obtained commercially as either standard size tubing or pipe. In one embodiment of the invention, the mold rings can be fabricated as cylinders, open at both ends, by purchasing tubing with the correct inside diameter and then cutting the tubing to proper length with a lathe, pipe cutter, hacksaw, band saw or other suitable cutting tool. The cut cylinders could then be coated with an oxide layer as described above.

Other types of molds could also be used. For example, a plate of mold material containing an array of blind holes of suitable diameter could be used. In this embodiment, the molds could be filled by simply pouring ceramic powder over the top of the mold array plate and brushing off the excess. The loose powder could be compacted if desired by vibrating the filled plate during filling or after it was filled. After filling, the plate could be introduced into a furnace and the ceramic powder fired to the correct degree of porosity.

The ceramic powder may be loaded into the mold by any method. For example, in one embodiment the mold may be loaded by pouring the powder into the mold or by manually packing the powder into the mold. In a preferred embodiment, the mold is loaded using a mold-filling device.

The mold-filling device includes means for engaging a mold ring. The device also includes means for providing ceramic powder into the mold ring. The device also includes means for releasing a filled mold ring.

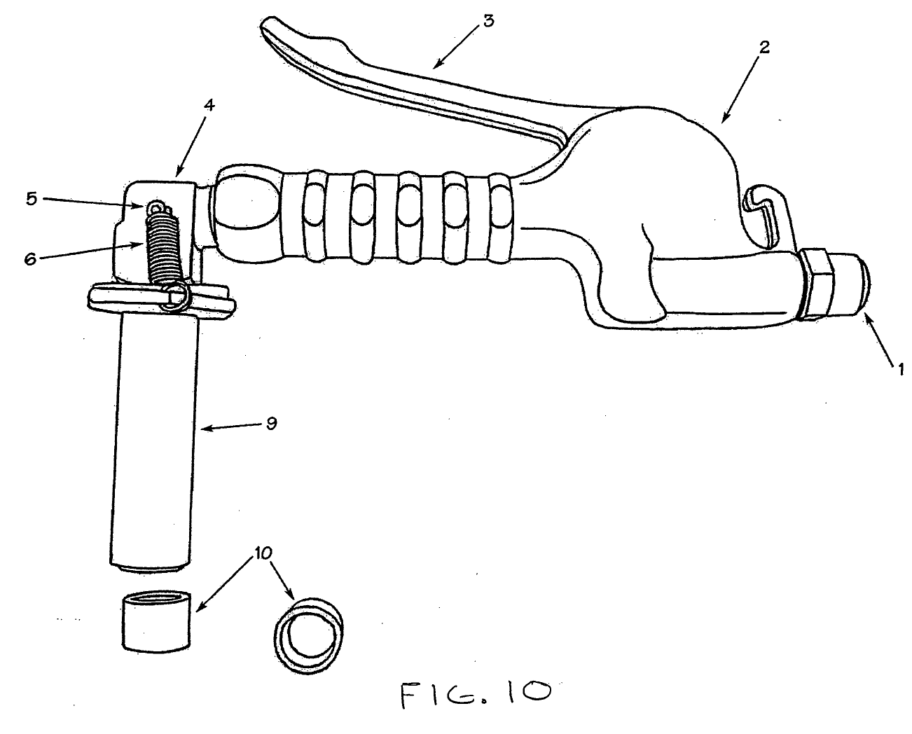

In a preferred embodiment, the device comprises a trigger-operated vacuum valve, an adapter fitting (elbow or coupling), a pair of concentric cylinders, the innermost being attached to the adapter fitting and the outermost affixed to valve body with a return spring. A three dimensional depiction of the device is shown in FIG. 10. The outer cylinder is concentric to, and moves freely over the inner cylinder. The inside diameter of the outer cylinder is sized to provide a slip fit for the mold ring.

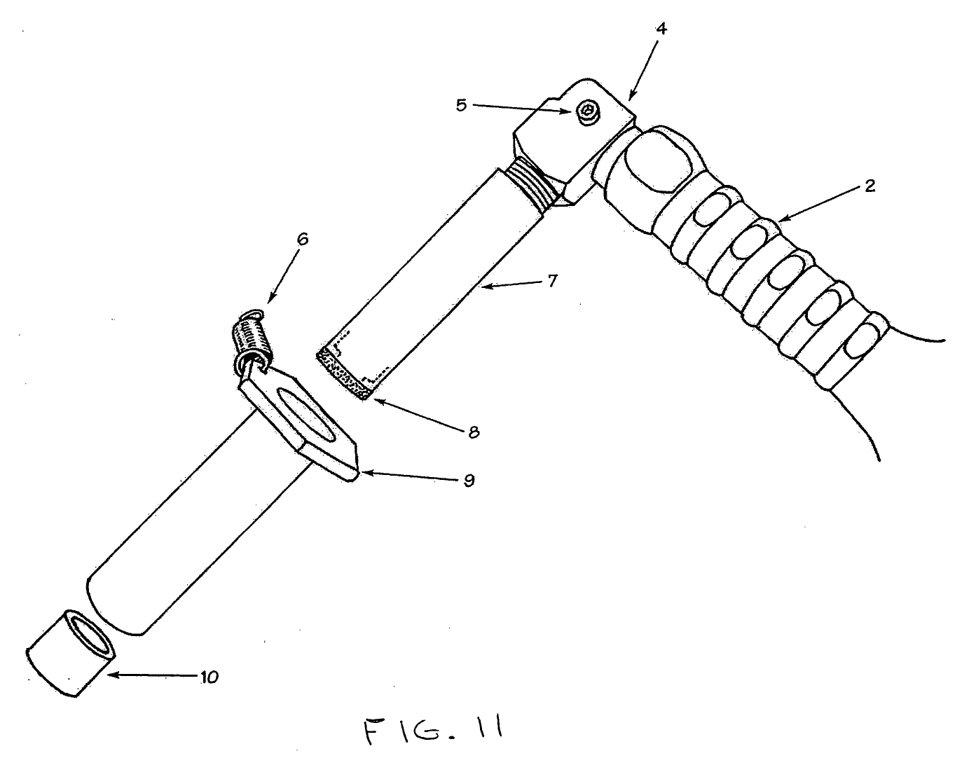

As shown in FIG. 10, the mold-filling device includes a trigger-operated vacuum valve 1 to be connected to a source of vacuum. Vacuum valve 1 is connected to air chamber 2. Trigger 3 is in airflow communication with vacuum valve 1 and creates and stops suction in the device. Adapter fitting 4 connects inner cylinder 7 (FIG. 11) to air chamber 2. Return spring 6 allows outer cylinder 9 to translate compared to adapter fitting 4 via spring connector fitting 5. The translational movement allows outer cylinder 9 to hold mold ring 10.

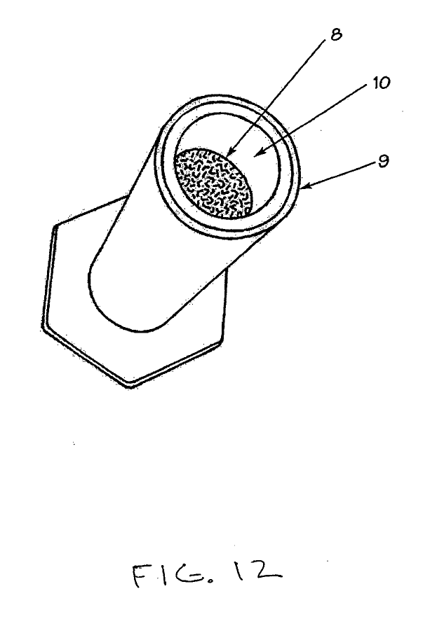

FIG. 11 shows a disassembled view of the device with the outer cylinder 9 sized to engage mold ring 10. Inner cylinder 7 is fitted with filter means 8 in order to prevent ceramic powder from entering inner cylinder 7 or air chamber 2. Filter means 8 is located at the end of the inner cylinder 7 opposite its point of attachment to adapter fitting 4. Preferably, a suitable metal or plastic frit filter or fine screen filter is used. FIG. 12 shows filter means 8 at the far end of the inner cylinder.

In order to fill a mold ring using the mold-filling device, outer cylinder 9 is advanced via return spring 6 and a mold ring 10 is inserted into the tip of outer cylinder 9. Mold ring 10 is situated such that the end away from the vacuum source is flush with the end of outer cylinder 9 and the end towards the vacuum is in contact with filter means 8 of inner cylinder 7.

Mold ring 10 is then filled by sucking ceramic powder into mold ring 10. In this step, trigger 3 is depressed to pull vacuum and the tip of the device containing mold ring 10 is inserted into the powder to be formed. Powder is sucked into mold ring 10 until it is full and the tip is then withdrawn from the powder. The vacuum to the device is then shut off by releasing trigger 3. The filled mold ring 10 is then discharged by retracting outer cylinder 9.

The mold-filling device allows rapid filling of mold rings with unconsolidated ceramic and rapid removal of the filled ring and placement on a firing tray or base plate. It also provides means for consolidation of the powder in the mold by vacuuming the ceramic powder into the mold. The device could also be fitted with a suitable vibration device, such as a piezoelectric transducer to allow further consolidation of powder during the vacuum-filling step.

Of course, any similar device could be used to fill molds of different shapes. The cross sectional shape of the inner and outer translating pieces would be the same cross sectional shape of the mold to be filled. Additionally, a similar device could be used that forces powder into molds by forced air instead of vacuum.

The filled mold can then be heated. For example, the filled mold may be loaded into a furnace. The temperature of the furnace may be selected based on the desired porosity of the ceramic ingot. For example, the times and temperatures required for the partial sintering vary greatly and depend on the composition and particle size distribution of the ceramic powders used to form the ceramic powder compact. The process conditions (time and temperature of sintering) should be chosen to produce an open cell ingot with a porosity in the range of 10-50% (v/v) and sufficient durability to allow handling without breakup. If a fully mature ceramic ingot is desired, the ceramic could be heated for a greater period of time at a higher temperature until substantially all the ceramic grains are fused.

The temperatures and times required to form either partially or fully dense porcelain ingots will vary with respect to the ceramic composition and particle size. For Cerinate® porcelain, the commercially available porcelain from Den-Mat Corporation described in U.S. Pat. No. 5,009,709, partial sintering is preferably carried out by holding powder compacts for 5 to 20 minutes at temperatures ranging from 760° C. (1400° F.) to 843° C. (1550° F.). This process could be carried out with any number of dental porcelains and other ceramics. For these materials, the preferred hold times and firing temperatures could vary over a broad range and could be adjusted for each ceramic to give a satisfactory product.

The ceramic is preferably porcelain but could be any material that is desired to be formed into a compact of a certain shape. More preferably, the ceramic is the porcelain described in U.S. Pat. No. 5,009,709.

The ceramic ingots can then be used in the formation of pressable ceramic restorations including inlays, onlays, crowns, and veneers. The process is identical to that described above except that a ceramic ingot made by the inventive method is substituted for a uniaxial die formed ingot. In the embodiment of a partially mature ceramic ingot, the amount of partially sintered ingots to use to form the restoration is determined from the measured wax weight as described above. The table below was used in this manner to determine the proper number of ingots. This table applies to the ceramic ingots made from the ceramic disclosed in U.S. Pat. No. 5,009,709. The use of different ceramic may slightly alter this correlation.

| Wax Weight (grams) | No. of 2 gram ingots |
|---|---|
| 0.50 g or less | 1 |
| 0.50 g to 1.30 g | 2 |

The present invention provides a simple method for making ceramic ingots. The method can be used for small-scale production but can be readily scaled up to provide large-scale production and can be automated. The method advantageously eliminates the need for uniaxial die pressing and the expensive press that goes along with that process. Thus, the inventive method could be implemented without undergoing large start-up costs. Furthermore the problems associated with die wear and frequent replacement are completely avoided. The inventive method also eliminates the need to use a binder so that the binder burnout step in the process can be eliminated.

The use of metal molds allows the use of very short sintering cycles since metal heats and cools rapidly due to its high thermal conductivity. The use of the mold-filling device makes high rates of production possible, the burnout step is eliminated and expensive die pressing equipment is unnecessary.

### EXAMPLES

### Example 1

### Fabrication of Metal Rings and Firing Trays

Metal rings were fabricated from Type 316 stainless steel tubing that had an outside diameter of 0.618 in and an inside diameter of 0.503 in. The bulk density of the ceramic powder to be compacted was 1.328 g/cm³ so the tubing was cut on a lathe with a cutoff tool to provide a ring with a height of 0.463 so that the ingots would have a mass of 2.00 grams. The rings were conditioned before use by firing three times in air at 1500° F. with a hold time of 12 minutes. A metal base plate that would accommodate 19 rings was prepared by cutting a circular tray 3.25 inches in diameter from 17 gauge 316 Stainless Steel sheet. The trays were conditioned before use by firing three times in air at 1500° F. with a hold time of 12 minutes.

### Example 2

### Preparation of Rings Provided With a Protective Titanium Dioxide Coating

Type 316 stainless steel rings, prepared as described above, were dipped in a TiO₂ sol that was prepared by the method described by Shin, Kim and Han. The rings were dipped a single time and allowed to drain and dry in the air before they were fired. The rings were then fired to 1500° F. (12 minute hold time) prior to coating. After firing, the rings were withdrawn from the solution and allowed to air-dry overnight. The rings were fired again at 1500° F. (12 minute hold) and were then deemed ready for use. Normally, ingots produced from uncoated rings exhibited some dark stains for the first few cycles of use but rings formed in this example produced ingots free of that defect as soon as they were placed in service.

### Example 3

### Preparation of Porous Porcelain Ingots by Manual Filling

Rings were packed manually by pressing a ring into a pile of Cerinate® porcelain powder and compressing the open ends of the ring with fingers to compact the powder contained therein. The rings were transferred to the firing tray and the tray was fired in air at 1500° F. with a twelve-minute hold time. The rings were then removed from the furnace and cooled in air. For cooling, the ingots were simply removed from the furnace, placed on a 12 mm thick cordierite plate and allowed to cool in the ambient air. Cooling times depended on air temperature, air flow and the mass that was being cooled. Cooling typically required 30 to 90 minutes. After cooling, the porous, sintered porcelain ingots fell out of the mold ring. After sintering, the bulk density of the porous, cylindrical porcelain ingots ranged from 1.72 to 1.92 g/Cm³ (fully sintered density 2.40 g/cm³).

### Example 4

### Preparation of Porous Porcelain Ingots by Manual Filling Using the Mold Filling Device

Rings were attached to the device by advancing the outer cylinder and inserting a mold ring in the tip. The vacuum valve trigger was then depressed and the tip containing the ring was inserted into a pile of the Cerinate® dental porcelain powder. The tip was withdrawn after the ring was full and the vacuum valve trigger was released. The outer cylinder was then retracted to discharge the filled mold ring. The rings were transferred to the firing tray and the tray was fired in air at 1500° F. with a twelve-minute hold time. The rings were then removed from the furnace and cooled in air. For cooling, the ingots were cooled by simply removing the packed rings from the furnace, placing the rings on a 12 mm thick cordierite plate and allowing them to cool in the ambient air. Cooling times depended on air temperature, air flow and the mass that is being cooled. Cooling typically required 30 to 90 minutes. After cooling, the porous, sintered porcelain ingots fell out of the mold rings. After sintering the bulk density of the porous, cylindrical porcelain ingot was about 1.98 g/Cm³. Using this technique an inexperienced operator could fill 20 rings in 4 minutes. Using rings whose preparation was described above, a single operator could produce porous dental porcelain ingots with an average weight of 1.98 g at a rate of 2300 pieces per eight-hour shift.

Although particular embodiments of this invention have been disclosed herein for purposes of explanation, further modifications or variations thereof will be apparent to those skilled in the art to which this invention pertains. Further, although certain processes have been described by a number of steps in a particular order, the present invention is not limited to any particular order. Further, those skilled in the art will recognize that many changes may be made to the lost wax technique without departing from the scope of the present invention. Further, although ceramic is the only material mentioned, the partial fusing process of the present invention applies to any material wherein grains can be partially fused and is not meant to be limited to ceramic. Thus, the scope of the present invention is not meant to be limited in any way.

What is claimed is:

1. A method for forming a ceramic ingot, the method comprising:
providing unconsolidated ceramic to a mold to substantially fill the mold;
subjecting the ceramic filled mold to a heating process to fuse together the grains of the ceramic; and
removing the fused ceramic from the mold to form a fused ceramic ingot.

2. The method of claim 1 wherein the heating process only partially fuses the grains of the ceramic.

3. The method of claim 2 wherein the fused ceramic ingot has a porosity of between about 10 and 50 percent.

4. The method of claim 1 wherein the heating process fully fuses the grains of the ceramic.

5. The method of claim 1 wherein the mold comprises a refractory metal with an oxide layer formed on the surface of the refractory metal.

6. The method of claim 5 wherein the refractory metal is selected from the group consisting of: stainless steel and nickel-chromium-iron alloys.

7. The method of claim 1 wherein the mold comprises a machinable ceramic.

8. The method of claim 7 wherein the machinable ceramic is selected from the group consisting of pyrophyllite and steatite.

9. The method of claim 1 wherein the heating process comprises heating at a temperature of between 1400 to 1550° F. for a period of 5 to 20 minutes.

10. The method of claim 9 wherein the heating process comprises heating at a temperature of 1500° F. for a period of 12 minutes.

11. The method of claim 1 wherein the ceramic comprises porcelain.

12. A method for forming a mold for forming a ceramic ingot, the method comprising:
forming a refractory metal structure having an inner size and shape of a ceramic ingot; and
forming an oxide layer on the surface of the refractory metal such that oxide layer is adherent to the refractory metal at temperatures of at least 1500° F.

13. The method of claim 12 wherein the refractory metal is selected from the group consisting of: stainless steel and nickel-chromium-iron alloys.

14. The method of claim 12 wherein the step of forming an oxide layer comprises dip coating the refractory metal in a sol selected from the group consisting of TiO₂, SiO₂ and Al₂O₃—P₂O₅.

15. The method of claim 14 wherein the step of forming an oxide layer further comprises heating the dip-coated refractory metal to a temperature of at least 1400° F. for a period of at least 5 minutes.

16. The method of claim 14 wherein the step of forming an oxide layer further comprises heating the dip-coated refractory metal to a temperature of 1500° F. for a period of 12 minutes.

17. The method of claim 15 wherein the step of forming an oxide layer further comprises heating the refractory metal to a temperature of at least 1400° F. for a period of at least 10 minutes in air before the step of dip coating.

18. The method of claim 15 wherein the step of forming an oxide layer further comprises heating the refractory metal to a temperature of 1500° F. for a period of 12 minutes in air before the step of dip coating.

19. A mold for forming a ceramic ingot, the mold comprising a refractory metal cylinder having an inner diameter equal to the desired diameter of the ceramic ingot, wherein the surface of the refractory metal has an oxide layer formed thereupon that is adherent to the refractory metal at temperatures of at least 1500° F.

20. The mold of claim 19 wherein the refractory metal is selected from the group consisting of: stainless steel and nickel-chromium-iron alloys.

21. The mold of claim 19 wherein the oxide layer comprises one of the compounds selected from the group consisting of TiO₂, SiO₂ and Al₂O₃—P₂O₅.

22. A mold for forming a ceramic ingot, the mold comprising a ceramic structure having an inner dimension equal to the desired inner dimension of the ceramic ingot to be formed, wherein the ceramic structure is refractory enough to withstand repeated firings at temperatures of at least 1500° F.

23. The mold of claim 22 wherein the ceramic structure comprises pyrophyllite or steatite.

24. A method for forming a mold for forming a ceramic ingot, the method comprising:
providing a ceramic;
shaping the ceramic into a structure having an inner size and shape of the ceramic ingot desired to be formed; and
firing the shaped ceramic to maturity.

25. The method for forming a mold of claim 24 wherein the firing step comprises heating the shaped ceramic to a temperature of at least 800° C.

26. The method for forming a mold of claim 25 wherein the firing step comprises heating the shaped ceramic to a temperature of at least 1100° C.

27. The method for forming a mold of claim 26 wherein the firing step comprises heating the shaped ceramic to a temperature of between 1100 to 1300° C.

28. The method for forming a mold of claim 24 wherein the ceramic is selected from the group consisting of pyrophyllite and steatite.

29. The method for forming a mold of claim 24 wherein the providing step comprises providing a contiguous mass of the ceramic and wherein the shaping step comprises at least one of the actions selected from the group consisting of turning, milling, drilling, filing and sawing.

30. The method for forming a mold of claim 24 wherein the providing step comprises providing a powder of the ceramic and wherein the shaping step comprises die pressing the powder into a structure having an inner size and shape of the ceramic ingot desired to be formed.

31. A mold filling device for filling a mold for forming a ceramic ingot, the device comprising:
means for engaging a mold for forming a ceramic ingot;
vacuum means for introducing unconsolidated ceramic into the mold; and
means for disengaging the filled mold.

32. A mold filling device, the device comprising:
two concentric cylinders; and
vacuum means for introducing unconsolidated ceramic into the mold, wherein the two concentric cylinders are operatively associated with each other such that the outer cylinder can translate along the length of the inner cylinder such that a mold may be inserted into the outer cylinder when the end of the outer cylinder away from the vacuum means is extended beyond the end of the inner cylinder away from the vacuum means.

33. The mold filling device of claim 32 further comprising filter means to prevent the unconsolidated ceramic from entering the inner cylinder.

34. A method for forming a ceramic dental restoration, the method comprising:
providing a ceramic powder to a mold to substantially fill the mold;
subjecting the powder inside the mold to a heating process to fuse together the grains of the ceramic powder;
removing the fused ceramic powder from the mold to form a fused ceramic ingot;
forming a wax model of a dental restoration;
forming a refractory material shape around the wax model;
removing the wax model from within the refractory material to create a void in the refractory material;
pressing the fused ceramic ingot into the void left by the wax model to form a ceramic model of a dental restoration; and
divesting the refractory material from the ceramic model to form a ceramic dental restoration.

35. A method for forming a ceramic ingot, the method comprising:
compacting an unconsolidated ceramic into a desired shape;
heating the unconsolidated ceramic to fuse together grains of the ceramic; and
cooling the fused ceramic to form a fused ceramic ingot, wherein the fused ceramic ingot is formed without the use of a binder material.
